(19) United States
(12) Patent Application Publication
(10) Pub. No.: US 2024/0339898 A1
(43) Pub. Date: Oct. 10, 2024

(54) METHOD FOR MANUFACTURING STATOR IRON CORE AND OUTER ROTOR MOTOR

(71) Applicant: AAC Acoustic Technologies (Shanghai) Co., Ltd., Shanghai (CN)

(72) Inventors: Chunjiang Li, Shanghai (CN); Bing Xie, Shanghai (CN); Liang Jiang, Shanghai (CN)

(21) Appl. No.: 18/401,282

(22) Filed: Dec. 29, 2023

Related U.S. Application Data
(63) Continuation of application No. PCT/CN2023/090873, filed on Apr. 26, 2023.

(30) Foreign Application Priority Data
Apr. 10, 2023 (CN) 202310387252.3

(51) Int. Cl. H02K 15/02; H02K 1/14

(52) U.S. Cl. CPC H02K 15/022; H02K 1/146

(57) ABSTRACT

Provided is a stator iron core manufacturing method. The method includes the following steps: manufacturing a strip-shaped iron core; performing winding around each of the yoke portions with a center line parallel to the second direction as an axis to form a stator winding; rolling the strip-shaped iron core, on which winding has been performed, into an integral outer ring structure with the tooth portions as a periphery; and inserting a prefabricated ring-structured intermediate core into the strip-shaped iron core rolled into a ring shape such that to obtain the stator iron core in an integrated structure. The present disclosure further discloses an outer rotor motor using the stator iron core manufacturing method. In the stator iron core, coils can be effectively wound neatly in the wire slot, with a high slot filling rate, a simple process, and easy manufacturing.

### TECHNICAL FIELD

The present disclosure relates to the technical field of motors, and in particular, to a method for manufacturing stator iron core and an outer rotor motor.

### BACKGROUND

At present, the motor is used more and more widely. An outer rotor motor has greater torque than an inner rotor motor, and thus is widely used especially in robots and unmanned aerial vehicles (UAVs). A stator iron core is an important component of the outer rotor motor.

In the related art, in the application of robots and UAVs, the outer rotor motor is powered by a low voltage. In the related art, a wire diameter of a coil wound around the stator iron core is relatively thick, and the coil is generally wound around the stator iron core by fly-cross winding.

However, in the related art, the coil is wound around the stator iron core by fly-cross winding, which makes it difficult to neatly insert thick wires into the wire slot and achieve a high slot filling rate. In addition, the structure of the stator iron core requires a complex manufacturing process, which is difficult to implement.

Therefore, there is a need to provide a new method and a new motor to solve the above technical problems.

### SUMMARY

In order to overcome the above technical problems, the present disclosure provides a method for manufacturing stator iron core and an outer rotor motor that can effectively wind coils neatly in the wire slot, with a high slot filling rate, a simple process, and easy manufacturing.

In order to achieve the above objective, in a first aspect, the present disclosure provides a method for manufacturing stator iron core, which is applied to an outer rotor motor with a stator iron core, including the following steps: step S1: manufacturing a strip-shaped iron core; the strip-shaped iron core including a plurality of strip-shaped punching sheets connected to one another sequentially along a first direction, each of the strip-shaped punching sheets including a tooth portion extending along the first direction and a yoke portion protruding from a side of the tooth portion along a second direction, all yoke portions being located on a same side of the tooth portions, the tooth portions being sequentially connected to one another into a long strip, each of the tooth portions being an arc segment for forming a same ring shape, a force-reducing groove being provided at a joint between adjacent tooth portions, and the force-reducing grooves being provided at a side of the joint close to the yoke portions; step S2: performing winding around each of the yoke portions with a center line parallel to the second direction as an axis to form a stator winding; step S3: rolling the strip-shaped iron core, on which winding has been performed through step S2, into an integral outer ring structure with the tooth portions as a periphery; and step S4: inserting a prefabricated ring-structured intermediate core into the ring-structured strip-shaped iron core completed in step S3, such that the intermediate core connects the yoke portions of the strip-shaped iron core to form an integral inner ring structure, to obtain the stator iron core with an integrated structure.

As an improvement, the method further includes step S5: machining the force-reducing grooves to form the stator iron core; the machining being to punch the force-reducing grooves to form deep groove structures or to cut off the joints between two adjacent tooth portions through positions of the force-reducing grooves, such that the force-reducing grooves form a fracture structure.

As an improvement, in step S2, two opposite sides of each of the yoke portions along an axial direction thereof are each provided with a first clamping structure, the first clamping structure and a part of the yoke portion between the tooth portion and the first clamping structure forms a wire slot, the stator winding is wound in the wire slot, and the first direction and the second direction are perpendicular to each other.

As an improvement, in step S3, the two tooth portions at head and tail ends of the strip-shaped iron core are connected to each other as an entirety, the joint of the two tooth portions is provided with one force-reducing groove, all the yoke portions are radially distributed around a ring center of the outer ring structure, and the yoke portions are arranged at intervals from one another.

As an improvement, the yoke portions are arranged at equal intervals from one another.

As an improvement, in step S4, the intermediate core is in a shape of a ring, an outer peripheral edge of the intermediate core is recessed to form a plurality of second clamping structures, and the plurality of second clamping structures have shapes matching those of the first clamping structures.

As an improvement, subsequent to step S5, the method for manufacturing stator iron core further includes: step S6: fixing a ring-structured clamping plate to an end face of the stator iron core.

As an improvement, subsequent to step S1, the method for manufacturing stator iron core further includes: step S11: machining a side of each of the yoke portions away from each of the tooth portions in the strip-shaped iron core to form an arc-shaped surface; each arc-shaped surface being a part for forming a same ring.

As an improvement, the strip-shaped punching sheets are made of iron.

In a second aspect, the present disclosure further provides an outer rotor motor. The outer rotor motor includes the stator iron core manufactured with the method for manufacturing stator iron core as provided above in the present disclosure.

Compared with the related art, the method for manufacturing stator iron core and the outer rotor motor of the present disclosure are both implemented through steps of the method for manufacturing stator iron core. The method for manufacturing stator iron core includes the following steps: manufacturing a strip-shaped iron core; performing winding around each of the yoke portions with a center line parallel to the second direction as an axis to form a stator winding; rolling the strip-shaped iron core, on which winding has been performed, into an annular outer ring structure with the tooth portions as a periphery; and inserting a prefabricated ring-structured intermediate core into the strip-shaped iron core with an outer ring structure, such that the intermediate core connects the yoke portions of the strip-shaped iron core to each other to form an integral inner ring structure. According to the steps of manufacturing a strip-shaped iron core in the above method, the strip-shaped iron core facilitates the winding to form the stator winding, so as to effectively wind coils neatly in the wire slot and achieve a high slot filling rate, then the strip-shaped iron core is rolled into an entirety to form the outer ring structure, and then the intermediate core is assembled to form the stator iron core with an integrated structure, such that the stator iron core has a simple manufacturing process and is easy to be manufactured. The method for manufacturing stator iron core and the outer rotor motor according to the present disclosure can effectively wind coils neatly in the wire slot, with a high slot filling rate, a simple process, and easy manufacturing.

### BRIEF DESCRIPTION OF DRAWINGS

In order to illustrate the technical solutions in the embodiments of the present disclosure more clearly, the accompanying drawings to be used in the description of the embodiments will be briefly introduced below. Obviously, the accompanying drawings in the following description are only some embodiments of the present disclosure. For those of ordinary skill in the art, other accompanying drawings can be obtained based on these drawings without creative efforts. In the drawings,

FIG. 1 is a flowchart block diagram of a method for manufacturing stator iron core according to the present disclosure;

FIG. 2 is a flowchart block diagram of the method for manufacturing stator iron core according to an embodiment of the present disclosure;

FIG. 3 is a schematic structural diagram of a strip-shaped iron core in step S1 of the method for manufacturing stator iron core according to the present disclosure;

FIG. 4 is a schematic structural diagram of a strip-shaped punching sheet in FIG. 3;

FIG. 5 is a schematic structural diagram of the strip-shaped iron core in step S11 of the method for manufacturing stator iron core according to the present disclosure;

FIG. 6 is a schematic structural diagram of the strip-shaped iron core with a stator winding in step S2 of the method for manufacturing stator iron core according to the present disclosure;

FIG. 7 is a schematic structural diagram of the strip-shaped iron core at the beginning of machining in step S3 of the method for manufacturing stator iron core according to the present disclosure;

FIG. 8 is a schematic structural diagram of the strip-shaped iron core during machining in step S3 of the method for manufacturing stator iron core according to the present disclosure;

FIG. 9 is a schematic structural diagram of the strip-shaped iron core machined in step S3 of the method for manufacturing stator iron core according to the present disclosure;

FIG. 10 is a schematic structural diagram of an intermediate core in step S4 of the method for manufacturing stator iron core according to the present disclosure;

FIG. 11 is a schematic structural diagram of assembly between the intermediate core and the strip-shaped iron core in step S4 of the method for manufacturing stator iron core according to the present disclosure;

FIG. 12 is a schematic structural diagram of the stator iron core in step S5 of the method for manufacturing stator iron core according to the present disclosure; and

FIG. 13 is a schematic structural diagram of the stator iron core in step S5 of the method for manufacturing stator iron core according to another embodiment of the present disclosure.

### DESCRIPTION OF EMBODIMENTS

The technical solutions in the embodiments of the present disclosure will be clearly and completely described below with reference to the accompanying drawings in the embodiments of the present disclosure. Obviously, the described embodiments are only some of the embodiments of the present disclosure, but not all of the embodiments. Based on the embodiments of the present disclosure, all other embodiments obtained by those of ordinary skill in the art without creative efforts fall within the protection scope of the present disclosure.

The present disclosure provides a method for manufacturing stator iron core.

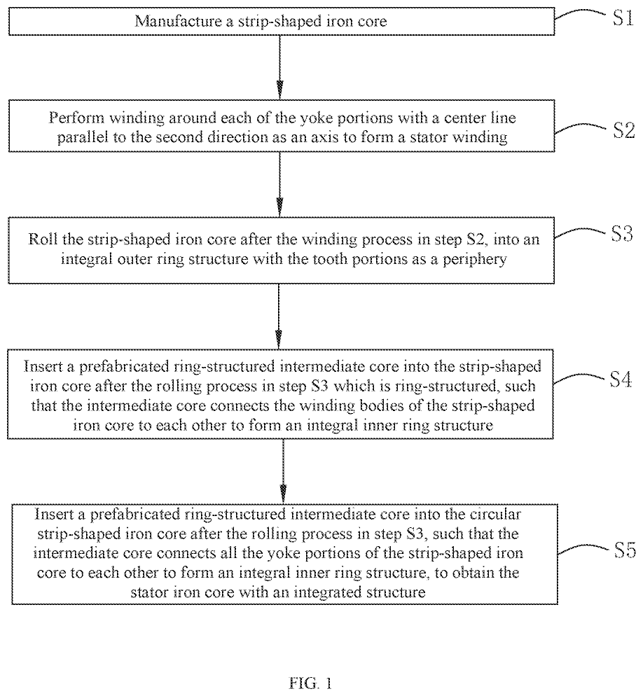

Referring to FIG. 1, in an embodiment the method for manufacturing stator iron core includes the following steps.

In step S1, a strip-shaped iron core is manufactured. The strip-shaped iron core includes a plurality of strip-shaped punching sheets connected to one another sequentially along a first direction. Each of the strip-shaped punching sheets includes a tooth portion extending along the first direction and a yoke portion protruding from a side of the tooth portion along a second direction. All yoke portions are provided at a same side of the tooth portions. The tooth portions are sequentially connected to one another to form a long strip, and each of the tooth portions is an arc segment for forming a same ring shape. A force-reducing groove is provided at a joint between adjacent tooth portions. The force-reducing grooves are provided at the sides of the joints close to the yoke portions.

In step S2, winding is performed around each of the yoke portions with a center line parallel to the second direction as an axis to form a stator winding.

In step S3, the strip-shaped iron core, on which winding has been performed through step S2, is rolled into an integral outer ring structure with the tooth portions as a periphery.

In step S4, a prefabricated ring-structured intermediate core is inserted into the ring-structured strip-shaped iron core completed in step S3, such that the intermediate core connects the yoke portions of the strip-shaped iron core to form an integral inner ring structure, to obtain the stator iron core with an integrated structure.

A detailed description is provided below through specific embodiments.

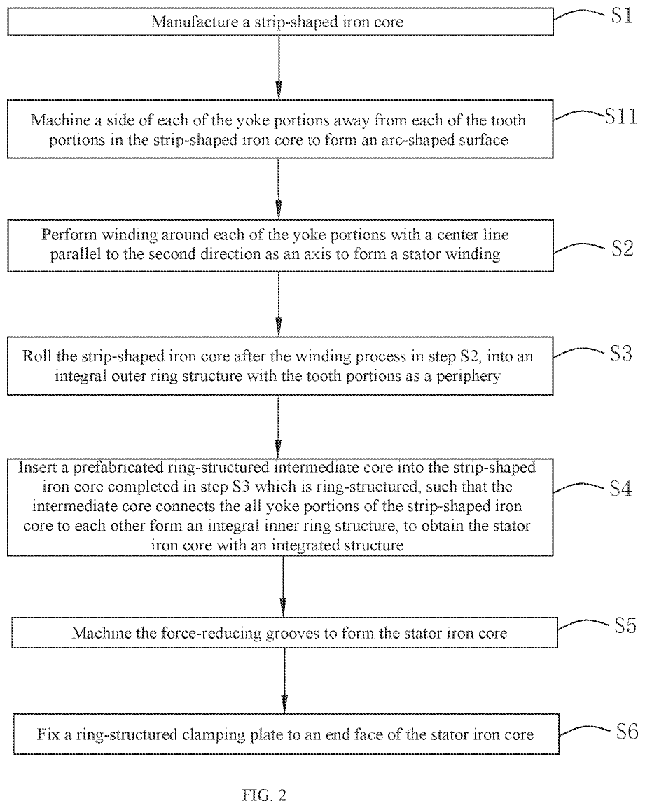

Referring to FIG. 2, the method for manufacturing stator iron core is applied to an outer rotor motor having a stator iron core 1000. That is, the stator iron core manufacturing method is used to manufacture the stator iron core 1000.

Optionally, the method for manufacturing stator iron core includes the following steps.

In step S1, a strip-shaped iron core 100 is manufactured.

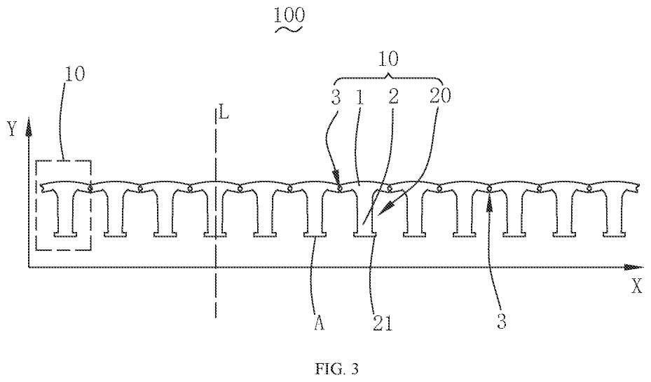

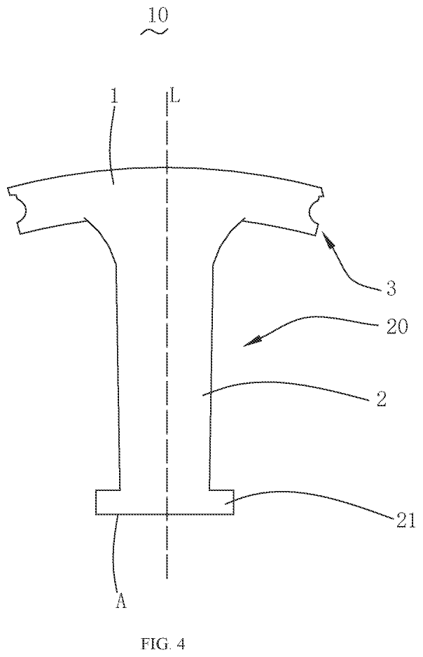

Referring to FIGS. 3 and 4 together, the strip-shaped iron core 100 includes a plurality of strip-shaped punching sheets 10 connected to one another sequentially along a first direction X, and each of the strip-shaped punching sheets 10 includes a tooth portion 1 sequentially arranged along the first direction X and a yoke portion 2 protruding from one side of the tooth portion 1 along a second direction Y.

All the yoke portions 2 are located on a same side of all the tooth portions 1, all the tooth portions 1 are sequentially connected to one another to form a long strip, and each of the tooth portions 1 is an arc segment for forming a same ring shape. All the tooth portions 1 together form a ring. It is to be noted that the tooth portions 1 presented as arc segments may all be arc segments for forming a same circle or non-concentric arc segments. Either is feasible as long as the tooth portions can form a ring shape together.

Two opposite sides of the tooth portion 1 along the first direction X are each provided with an inwardly concave arc. A joint between two adjacent tooth portions 1 is provided with a force-reducing groove 3. The force-reducing groove 3 is located at a side of the joint close to the yoke portion 2. The arrangement of the force-reducing grooves 3 can make it easier to roll the tooth portions 1, which are connected to one another to form a long strip, into a ring shape. That is, the joint between two adjacent tooth portions 1 is thinned such that the position is close to a fracture structure to obstruct passing of a magnetic line of force, making it easier for the magnetic line of force at this position to saturate. Therefore, the shape of the force-reducing groove 3 is not limited, which may be a concave elongated groove, a concave arc-shaped groove, or the like.

In this embodiment, the strip-shaped punching sheets 10 are made of iron.

In this implementation, as an improvement, each of the strip-shaped punching sheets 10 is arranged mirror-symmetrically along the center line L parallel to the second direction Y, which facilitates machining. In some embodiments, the strip-shaped punching sheet may alternatively be arranged asymmetrically.

In this embodiment, subsequent to step S1, the method for manufacturing stator iron core further includes the following step.

In step S11, a side of each of the yoke portions 2 away from each of the tooth portions 1 in the strip-shaped iron core 100 is machined to form an arc-shaped surface.

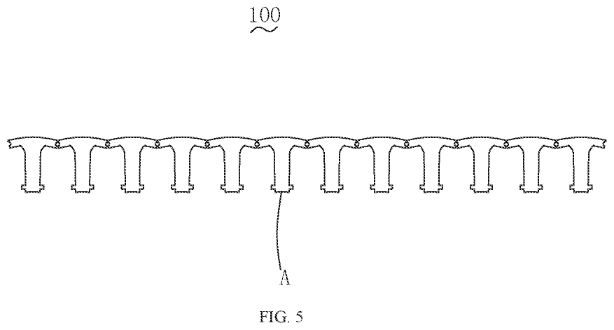

Referring to FIG. 5, for a surface A in FIG. 5, in step S11, the surface A in step S1 is machined into an arc-shaped surface, that is, an arc-shaped surface A. Each of the arc-shaped surfaces A is a part for forming a same ring, but is not limited to forming a same circle. As an improvement, each of the arc-shaped surfaces A is a part of a concentric circle of a circle surrounded by the tooth portions 1, which is more convenient for standard machining.

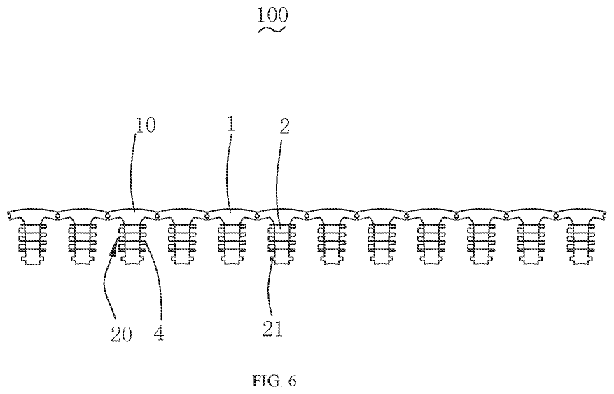

In step S2, winding is performed around each of the yoke portions 2 with a center line L parallel to the second direction Y as an axis to form a stator winding 4, as shown in FIG. 6. The stator winding 4, on which the winding has been performed through step S2, has a simple process and a high slot filling rate.

Still referring to FIG. 6, two opposite sides of each of the yoke portions 2 along an axial direction thereof are each provided with a first clamping structure 21, a part of the yoke portion 2 between the tooth portion 1 and the first clamping structure 21 forms a wire slot 20, and the stator winding 4 is wound in the wire slot 20. The strip-shaped punching sheets 10 each have a strip-shaped structure extending along the first direction X, and space the yoke portions 2 apart, then the wire slot 20 is formed at a partial position of each of the yoke portions 2, and machining and winding are performed in the wire slot 20, which can effectively wind coils neatly in the wire slot 20 and achieve a high slot filling rate.

In this implementation, the first direction X and the second direction Y are perpendicular to each other.

In step S3, the strip-shaped iron core 100, on which winding has been performed through step S2, is rolled into an integral outer ring structure with the tooth portions 1 as a periphery. In this step, the outer ring structure may be circular or non-circular.

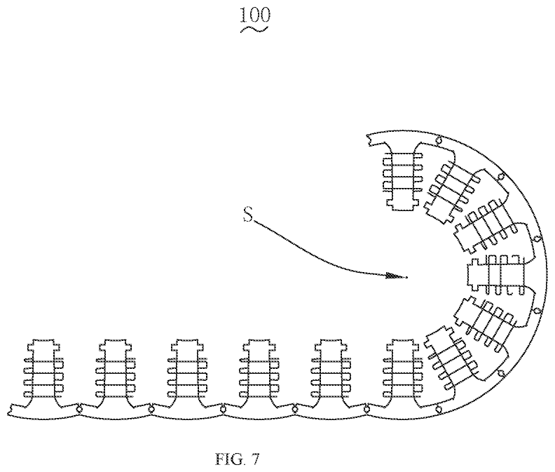

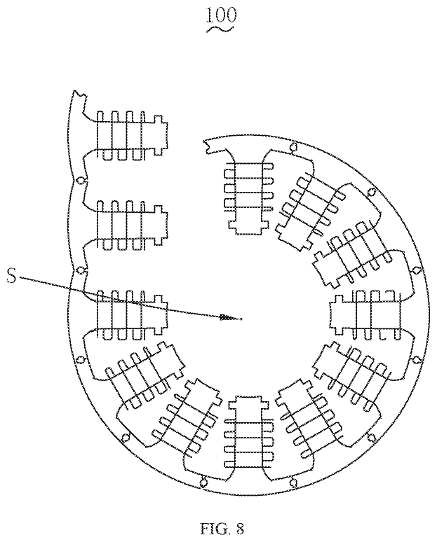

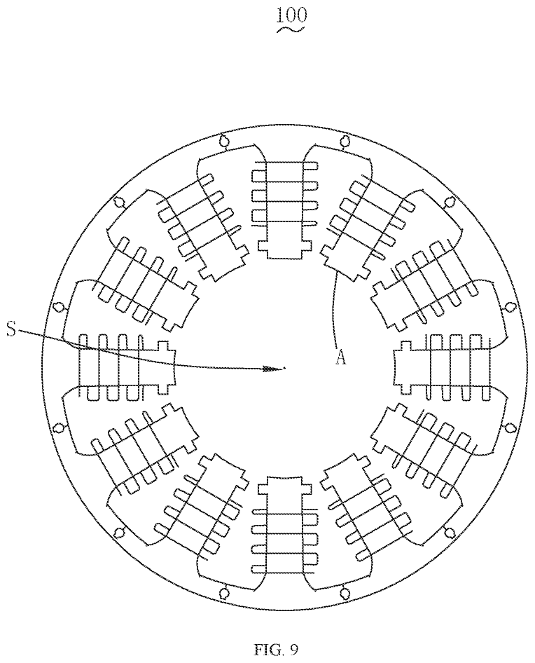

Referring to FIGS. 7 to 9 together, the strip-shaped iron core 100 is rolled into an integral ring structure. After machining the stator winding 4 with a high slot filling rate in step S2, the strip-shaped iron core 100 is machined into a shape of the stator iron core 1000 required by the outer rotor motor.

The two tooth portions 1 at head and tail ends of the strip-shaped iron core 100 are connected to each other as an entirety, the joint of the two tooth portions 1 is provided with one of the force-reducing grooves 3, all the yoke portions 2 are radially distributed around a ring center S of the outer ring structure, and the yoke portions 2 are arranged at intervals from one another. As an improvement, the yoke portions 2 are arranged at an equal interval from one another, with a more uniform magnetic field. As an improvement, the arc-shaped surface A may alternatively be a corresponding part forming a circle with the ring center S as a center. That is, when the outer ring structure is circular, an inner ring surrounded by the arc-shaped surfaces A may be a circle concentric with an outer circle, or non-circular. A specific shape thereof is not limited.

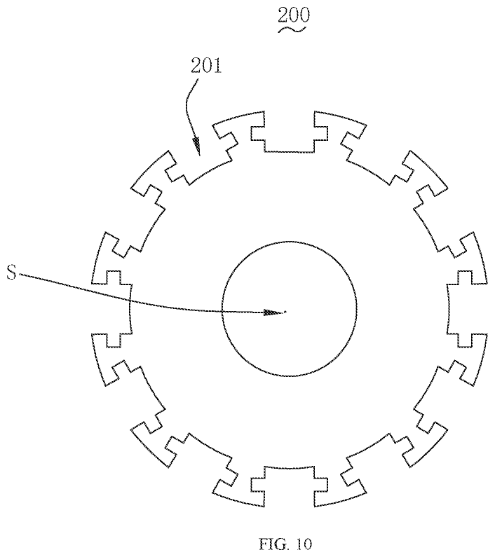

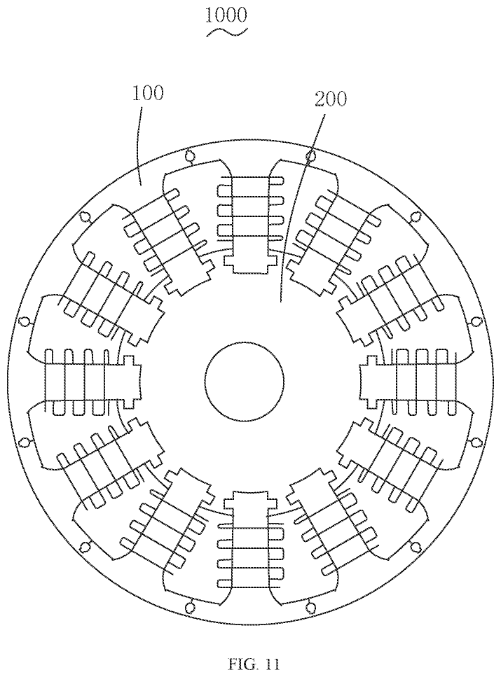

In step S4, a prefabricated ring-structured intermediate core 200 is inserted into the circular strip-shaped iron core 100 completed in step S3, such that the intermediate core 200 connects the yoke portions 2 of the strip-shaped iron core 100 to each other to form an integral inner ring structure, to obtain the stator iron core 1000 with an integrated structure. The inner ring structure and the outer ring structure may be concentric circles, non-concentric circles, or non-concentric rings, referring to FIGS. 10 and 11.

In an embodiment, the intermediate core 200 is in a shape of a ring, optionally in a shape of a circle. An outer peripheral edge of the intermediate core 200 is recessed to form a plurality of second clamping structures 201. Each second clamping structure 201 has a shape matching that of an end of the yoke portions 2 away from the tooth portions 1 and that of each first clamping structure. Therefore, each second clamping structure 201 is engaged and fixed to two first clamping structures 21 on a same yoke portion 2, such that an end of the yoke portion 2 away from the tooth portions 1 forms an integral inner ring structure.

It is to be noted that the first clamping structure 21 may be a convex structure or a concave structure. The two first clamping structures 21 at two sides of the same yoke portion 2 are both in a convex structure, both in a concave structure, or in a combination of a convex structure and a concave structure. In this implementation, as an improvement, the two first clamping structures 21 on the two sides of the same yoke portion 2 are both a convex structure.

The stator iron core 1000 obtained with the above method has an integral periphery, and thus has a stronger structure. However, since the position of the force-reducing groove 3 between adjacent tooth portions 1 is still a connected entirety, it is equivalent to thinning the joint between two adjacent tooth portions 1. Since the phenomenon of cross magnetization still exists at the joint, a minority of magnetic lines of force cannot flow to an outer rotor, thereby weakening magnetic field performance.

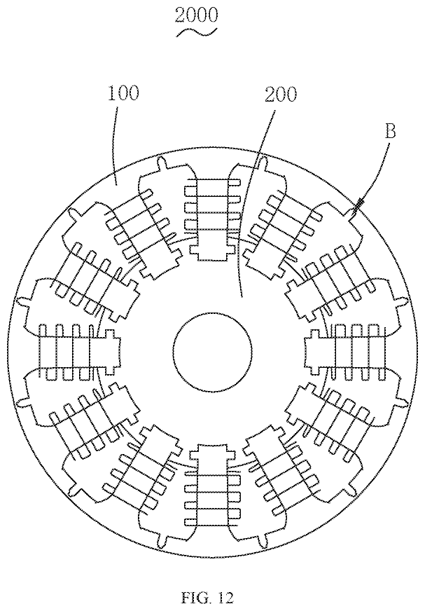

As shown in FIG. 12, as an improvement, the method further includes step S5: machining the force-reducing grooves 3 to form the stator iron core 2000. In an embodiment, the machining is to punch the force-reducing grooves 3 to form a deep groove structures B. That is, the joints at the positions of the force-reducing grooves 3 are thinned to improve the magnetic field performance as much as possible.

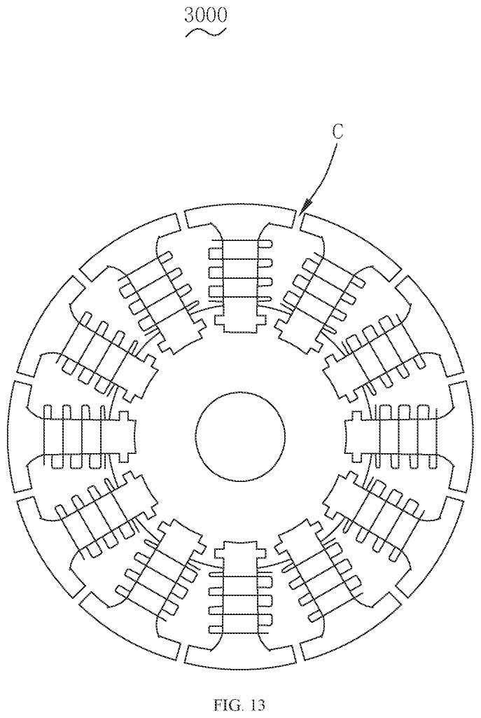

Alternatively, in another embodiment, as shown in FIG. 13, the machining is to cut off the joint between two adjacent tooth portions 1 from the position of the force-reducing groove 3 such that a fracture structure C is formed in the force-reducing groove 3. As a result, the two adjacent tooth portions 1 are spaced apart from each other to obtain a stator iron core 3000. The stator iron core 3000 effectively prevents a phenomenon of magnetic resistance, such that all of the magnetic lines of force of the stator winding 4 can flow to the outer rotor, resulting in better magnetic field performance.

In this embodiment, subsequent to step S5, the method for manufacturing stator iron core further includes the following step.

In step S6, a ring-structured clamping plate (not shown) is fixed to an end face of the stator iron core. In order to enhance structural strength of the stator iron core 1000 in this embodiment of the present disclosure or the stator iron core 2000 in another embodiment or the stator iron core 3000 in another embodiment, in particular, to enhance the structural strength of the stator iron core 3000. In this embodiment, in addition to fixing the clamping plate to the stator iron core to enhance the structural strength, the stator iron core may also be integrally reinforced by injection molding or plastic sealing. Certainly, the present disclosure is not limited to the above manners.

An embodiment of the present disclosure further provides an outer rotor motor. The outer rotor motor includes the stator iron core manufactured with the stator iron core manufacturing method.

The outer rotor motor provided in this embodiment of the present disclosure can realize various implementations in the embodiments of the stator iron core manufacturing method, as well as corresponding beneficial effects. To avoid repetition, details are not described again herein.

This implementation mentioned in the embodiments of the present disclosure is to facilitate the description. The above disclosure is only preferred embodiments of the present disclosure, which should not be interpreted to limit the scope of the present disclosure. Therefore, equivalent changes based on the claims of the present disclosure shall still fall within the scope of the present disclosure.

Compared with the related art, the stator iron core manufacturing method and the outer rotor motor of the present disclosure are both implemented through steps of the stator iron core manufacturing method. The method for manufacturing stator iron core includes the following steps: manufacturing a strip-shaped iron core; performing winding around each of the yoke portions with a center line parallel to the second direction as an axis to form a stator winding; rolling the strip-shaped iron core, on which winding has been performed, into an annular outer ring structure with the tooth portions as a periphery; and inserting a prefabricated ring-structured intermediate core into the strip-shaped iron core with an outer ring structure, such that the intermediate core connects the yoke portions of the strip-shaped iron core to each other to form an integral inner ring structure. According to the step of manufacturing a strip-shaped iron core in the above method, the strip-shaped iron core facilitates the winding to form the stator winding, so as to effectively wind coils neatly in the wire slot and achieve a high slot filling rate, then the strip-shaped iron core is rolled into an entirety to form the outer ring structure, and then the intermediate core is assembled to form the stator iron core with an integrated structure, such that he stator iron core has a simple manufacturing process and is easy to manufacture. The method for manufacturing stator iron core and the outer rotor motor according to the present disclosure can effectively wind coils neatly in the wire slot, with a high slot filling rate, a simple process, and easy manufacturing.

The above are only embodiments of the present disclosure and not thus intended to limit the patent scope of the present disclosure. All equivalent structures or equivalent flow transformations made by virtue of contents of the specification and the drawings of the present disclosure or direct or indirect application of the contents to the other related technical fields shall fall within the patent protection scope of the present disclosure.

What is claimed is:

1. A method for manufacturing stator iron core, applied to an outer rotor motor, comprising:
step S1: manufacturing a strip-shaped iron core, wherein the strip-shaped iron core comprises a plurality of strip-shaped punching sheets connected to one another sequentially along a first direction, each of the plurality of strip-shaped punching sheets comprises a tooth portion extending along the first direction and a yoke portion protruding from a side of the tooth portion along a second direction, all yoke portions are provided at a same side of the tooth portions, the tooth portions are sequentially connected to one another into a long strip, each of the tooth portions is an arc segment for forming a same ring shape, a force-reducing groove is provided at a joint between adjacent tooth portions, and the force-reducing groove is provided at a side of the joint close to the yoke portion;
step S2: performing winding around each of the yoke portions with a center line parallel to the second direction as an axis to form a stator winding;
step S3: rolling the strip-shaped iron core, after the winding process in step S2, into an integral outer ring structure with the tooth portions as a periphery; and
step S4: inserting a prefabricated ring-structured intermediate core into the ring-structured strip-shaped iron core after the rolling process in step S3, such that the intermediate core connects all the yoke portions of the strip-shaped iron core to each other to form an integral inner ring structure, to obtain the stator iron core with an integrated structure.

2. The method as described in claim 1, further comprising:
step S5: machining the force-reducing groove to form the stator iron core; wherein said machining comprises punching the force-reducing groove to form a deep groove structure or to cut off the joint between two adjacent tooth portions at a position of the force-reducing groove, in such a manner that the force-reducing groove form a cut structure.

3. The method as described in claim 1, wherein in step S2, a first clamping structure is provided at each of two opposite sides of each of the yoke portions along an axial direction of each of the yoke portions, the first clamping structure and a part of the yoke portion between the tooth portion and the first clamping structure forms a wire slot, and the stator winding is wound in the wire slot, and wherein the first direction and the second direction are perpendicular to each other.

4. The method as described in claim 3, wherein in step S3, two tooth portions at head and tail ends of the strip-shaped iron core are connected to each other to form an entirety, a joint of the two tooth portions is provided with one force-reducing groove, all the yoke portions are radially distributed around a ring center of the outer ring structure and arranged at intervals from one another.

5. The method as described in claim 4, wherein all the yoke portions are arranged at equal intervals from one another.

6. The method as described in claim 1, wherein in step S4, the intermediate core is in a shape of a ring, an outer peripheral edge of the intermediate core is recessed to form a plurality of second clamping structures, and the second clamping structures have shapes matching shapes of the first clamping structures.

7. The method as described in claim 1, wherein subsequent to step S5, the method further comprises:
step S6: fixing a ring-structured clamping plate to an end face of the stator iron core.

8. The method as described in claim 1, wherein subsequent to step S1, the method further comprises:
step S11: machining a side of each of the yoke portions away from each of the tooth portions in the strip-shaped iron core to form an arc-shaped surface, wherein the arc-shaped surface is a part for forming a same ring.

9. The method as described in claim 1, wherein the plurality of strip-shaped punching sheets are made of iron.

10. An outer rotor motor, wherein the outer rotor motor comprises the stator iron core manufactured with the method as described in claim 1.
